(19) United States
(12) Patent Application Publication
(10) Pub. No.: US 2006/0212343 A1
(43) Pub. Date: Sep. 21, 2006

(54) Methods relating to reliability in product design and process engineering

(75) Inventors: Liem Ferryanto, Waterloo (CA); Patricia Cooper Barfoot, Waterloo (CA); Benson Tendler, Waterloo (CA)

Correspondence Address: INTEGRAL INTELLECTUAL PROPERTY INC., 44 LONGWOOD DRIVE, TORONTO, ON, M3B 1T8, CA

(73) Assignee: Research In Motion Limited

(21) Appl. No.: 11/082,980

(22) Filed: Mar. 18, 2005

(51) Int. Cl. H04M 3/51; G06F 11/34

(52) U.S. Cl. 705/11

(57) ABSTRACT

A cumulative distribution function (CDF) that represents reliability of a product or process is optimized with respect to one or more critical probabilistic controllable variables of the product or process that it is feasible to control. Optimal mean values for those critical probabilistic controllable variables are determined.

### BACKGROUND OF THE INVENTION

The invention generally relates to designing products and processes for reliability. In particular, embodiments of the invention relate to a method to optimize the reliability of a product or process.

As defined in IEEE Standard Computer Dictionary: A Compilation of IEEE Standard Computer Glossaries (New York, N.Y.: 1990), reliability is the ability of a system or component to perform its required functions under stated conditions for a specified period of time. In today's competitive market, a commitment to product quality and reliability is a necessity. Customers have high expectations for the reliability of the products they buy, and the companies that don't meet those expectations fail. The primary advantages of building reliable products are that reputation improves and costs decrease.

### BRIEF DESCRIPTION OF THE DRAWINGS AND APPENDIX

Embodiments of the invention are illustrated by way of example and not limitation in the figures of the accompanying drawings, in which like reference numerals indicate corresponding, analogous or similar elements, and in which:

FIG. 1 is a flowchart of a method for improving the reliability of a product or process, according to an embodiment of the invention;

FIG. 2A is a schematic illustration of an exemplary engineered model for a general product or process, helpful in understanding embodiments of the invention;

FIG. 2B is a schematic illustration of an exemplary engineered model for a ball grid array (BGA)—printed wiring board (PWB) system, helpful in understanding embodiments of the invention;

FIG. 3 is a graph of a cumulative distribution function for an exemplary simulated BGA-PWB system, showing the cumulative percentage probability as a function of shear strain;

FIGS. 4A and 4B are illustrations of an exemplary cumulative distribution function based on a normal distribution, and shifted and squeezed versions thereof, respectively, helpful in understanding embodiments of the invention;

FIGS. 5A and 5B are mappings of the shear strain range versus α_{PWB}, the coefficient of thermal expansion of the PWB;

FIG. 6 is a mapping of the shear strain range versus h, the nominal height of the solder joint;

FIG. 7 is a mapping of the shear strain range versus L, the nominal diagonal length of the BGA, at two different values of ΔT, the temperature difference between the PWB and the BGA;

FIGS. 8A, 8B, 8C, 8D and 8E are plots of the shear strain range and the standard deviation of the shear strain range as a function of L, h, α_{PWB}, α_{BGA} (the coefficient of thermal expansion of the BGA), and ΔT, respectively;

FIG. 9 shows plots of the shear strain range and the standard deviation of the shear strain range as a function of L, h, ΔT, α_{PWB} and α_{BGA}, with indications of optimal values for these design variables;

Figures 10A and 10B are graphs of a cumulative distribution function as a function of shear strain range in a Setting 1 of non-optimal values and a Setting 2 of optimal values, respectively;

Figures 11A and 11B are graphs of a cumulative distribution function as a function of the number of cycles to failure in a Setting 1 of non-optimal values and a Setting 2 of optimal values, respectively;

FIGS. 12A and 12B are bar graphs of the percent contribution of design variables to the standard deviation of the shear strain range in Setting 1 and Setting 2, respectively; and

Appendix A is a derivation of equations for functional ANOVA sensitivity analysis.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, components and circuits have not been described in detail so as not to obscure the embodiments of the invention.

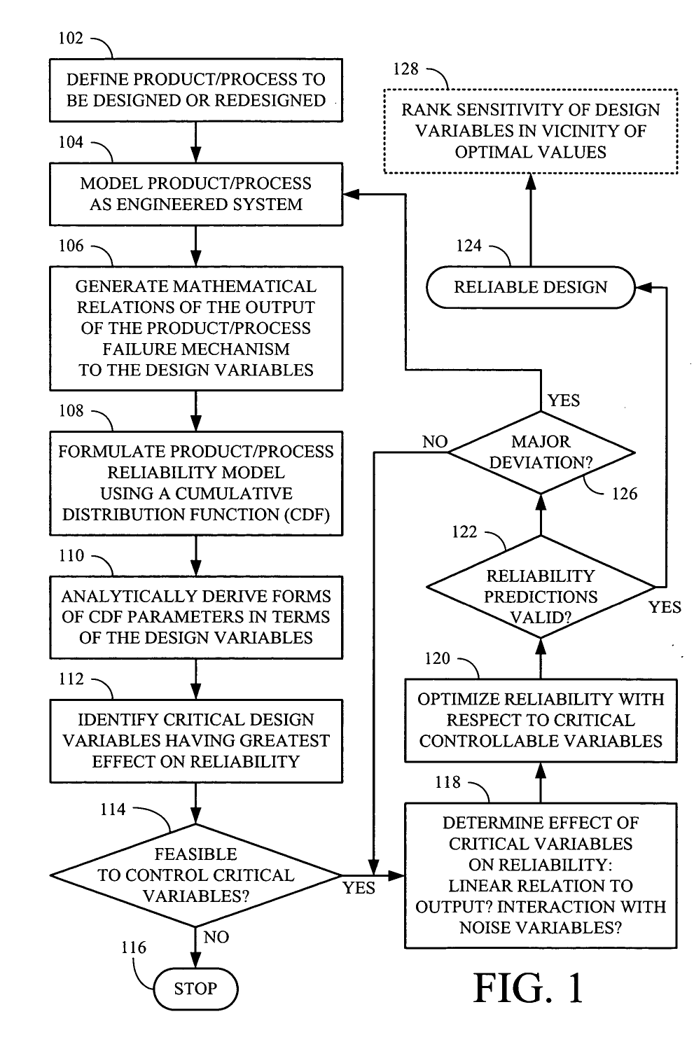

FIG. 1 is a flowchart of a method for improving the reliability of a product or process, according to an embodiment of the invention.

At 102, the product or process to be designed or redesigned is defined. The scope of the problem is identified. This may be accomplished using the customer's insight, engineering and manufacturing knowledge, object and process mapping, and other suitable sources of information and techniques.

For example, in ball grid array (BGA) products, a primary failure mechanism is solder joint thermo-mechanical fatigue. The solder connections between the printed wiring board (PWB) and the BGA carrier substrate are stressed in shear by the differences in thermal expansion of the PWB and the BGA carrier substrate. Printed wiring boards are also known as printed circuit boards (PCBs). Changes in temperature induce cyclic strain. Cyclic strain causes an accumulation of damage that results in the development of cracks and eventually fractures. Therefore, for BGA products, the problem identified at 102 in this example is solder fatigue.

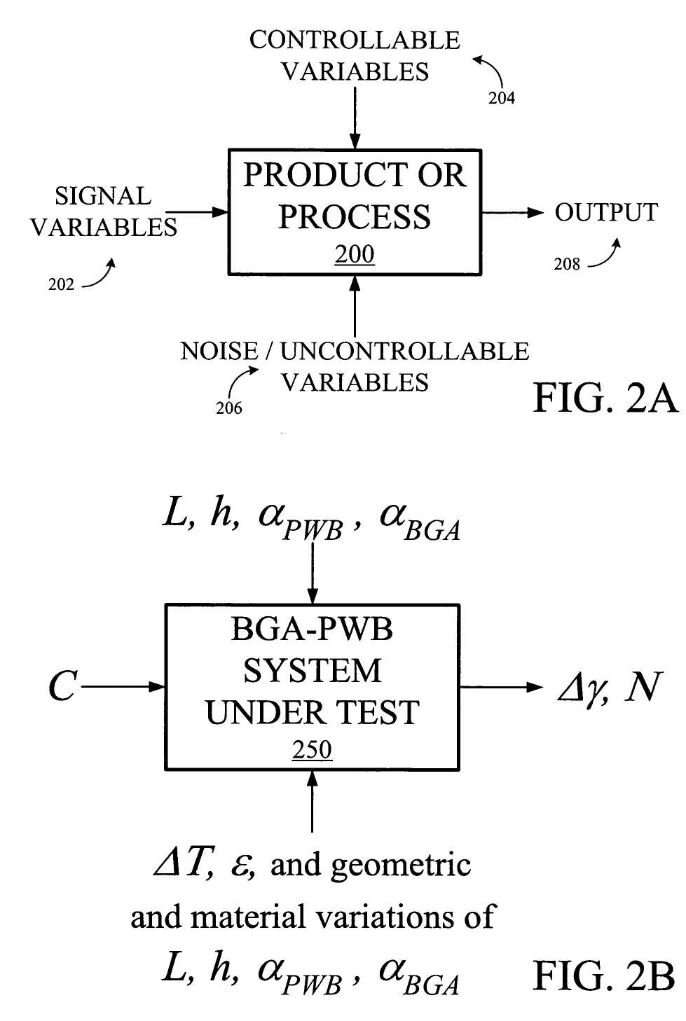

At 104, the product or process to be designed or redesigned is modeled as an engineered system. The model is a system in the physical space that transforms, flows and changes energy, mass and information. The model may be derived based on manufacturing and engineering knowledge. As shown in FIG. 2A, the model of the product or process 200 involves different design variables, which can be categorized, for example, as signal variables 202 that drive the outputs, controllable variables 204 that can be chosen by a designer of the product or process, and noise or uncontrollable variables 206 that cannot be changed by the designer but values of which give variability to the outputs 208. Noise variables may be included in the model based on engineering knowledge and/or experimental observations. For example, the observable noise variables may arise from unit-to-unit variation, the internal and/or external operating environment, degradation or duty cycles, or interactions among variables.

For the BGA example above, according to the Engelmaier thermo-mechanical fatigue model, the mean number of cycles to failure, N, is as follows:

$$N = \frac{1}{2} {( \frac{Δγ}{2 ɛ} )}^{1 / C} , \qquad ( 1 )$$

where
the mean of the shear strain range is

$$μ ( Δγ ) = ξ \frac{L ( {α}_{PWB} - {α}_{BGA} ) Δ T}{2 h} ; \qquad ( 2 )$$
the fatigue ductility exponent is

$$C = - 0.442 - 6 \times {10}^{- 4} {T}_{S} + 1.7 \times {10}^{- 2} ln ( 1 + \frac{360}{{t}_{D}} ) ;$$
the fatigue ductility coefficient is ε=0.325;
ξ is an empirical correction factor (and equals 0.54 for plastic BGA);
L [mm] is the nominal diagonal BGA length;
h [mm] is the nominal height of a solder joint (typically assumed to be the collapsed ball height);
α_{PWB} [ppm/° C.] is the coefficient of thermal expansion of the PWB;
α_{BGA} [ppm/° C.] is the coefficient of thermal expansion of the BGA;
ΔT [° C.] is the difference in temperature between the BGA and the PWB;
Tₛ [° C.] is the mean cyclic temperature of the solder; and
t_{D} is the dwell time.

As illustrated in FIG. 2B, which is an engineered model for a BGA-PWB system 250, based on the Engelmaier model,
C is a signal variable that drives the outputs;
L,h, α_{PWB} and α_{BGA} are controllable variables that can be chosen by a designer;
ΔT, ε, and geometric and material variations of L, h, α_{PWB} and α_{BGA}, are observable noise variables; and
Δγ and N are outputs.

At 106, mathematical relations (denoted “transfer functions”) between the output of the product or process failure mechanism and the design variables are generated. The product or process need not be a linear, time-invariant system. The transfer functions may be derived from first principles of physics or empirically (for example, from a response surface of hardware or computer experimental designs).

In the BGA example above, the mathematical relations of the design variables C, L, h, α_{PWB}, α_{BGA}, ΔT and ε to the outputs Δγ and N are given by the Engelmaier equations above.

At 108, a cumulative distribution function to describe the reliability of the product or process is formulated. The cumulative distribution function may be formulated analytically, or may be determined from simulations of inputs based on the transfer functions generated at 106, or may be generated from historical data, physics, observations, experiments or any combination thereof or any other suitable method.

For example, the transfer functions in the BGA example above provide a mathematical relationship between the inputs and the outputs, namely the range of shear strain and the number of cycles to failure. Simulations of the inputs may be used to calculate the shear strain range and the number of cycles to failure, and to calculate therefrom the cumulative distribution function as a function of shear strain range (or as a function of the number of cycles to failure).

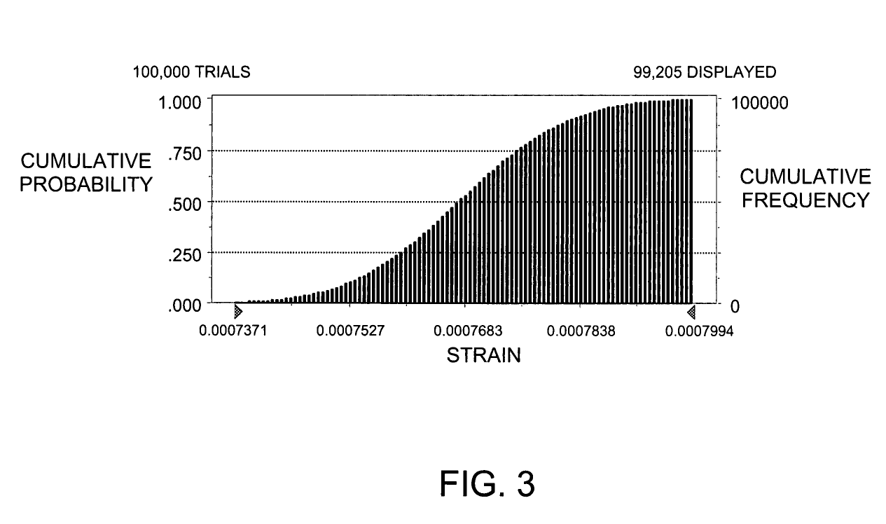

FIG. 3 is a graph of a cumulative distribution function (CDF) for an exemplary simulated BGA-PWB system, showing the cumulative percentage probability as a function of shear strain range. For example, according to this graph, the probability that the random variable, shear strain range, is less than or equal to a given value, say 0.00077605, is 0.75. Higher values of shear strain range are related to higher rates of failure, since at higher shear strain range, fewer cycles are required to reach failure. Therefore, intuitively, improving the reliability of the product may be achieved by “shifting” the CDF to the left and/or by “raising” the CDF.

The cumulative distribution function is then formulated in terms of parameters. The parameters will depend upon the distribution that best fits the cumulative distribution function. For example, the parameters of the normal distribution are the mean μ and the standard deviation σ, the parameter of the exponential distribution is the rate λ, the parameters of the two-parameter Weibull distribution are the shape β and the scale η, and the parameters of the lognormal distribution are the shape σ, the location θ, and the scale m. The cumulative distribution function may be more complicated than any of the common distributions.

In the BGA example, the cumulative distribution function may be best fit as a normal distribution, and therefore is formulated as follows:

$$P ( Δγ \leq Y ) = Φ ( \frac{Y - μ ( Δγ )}{σ ( Δγ )} ) , \qquad ( 4 )$$

where P is the cumulative percentage probability that the shear strain range Δγ is less than or equal to a threshold shear strain range Y. This formulation expresses that the parameters of the function Φ are the mean μ(Δγ) of the shear strain range and the standard distribution σ(Δγ) of the shear strain range.

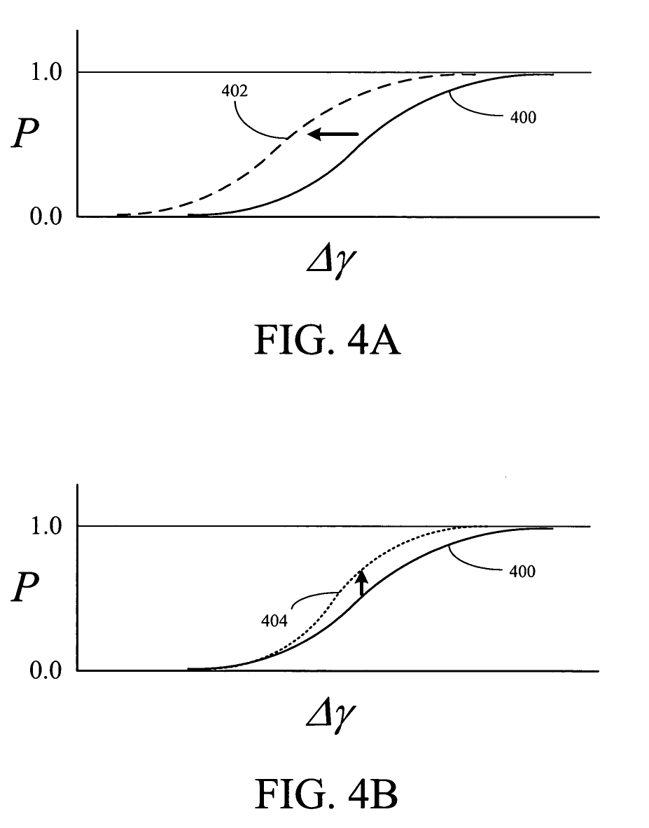

An exemplary cumulative distribution function based on a normal distribution is illustrated in FIGS. 4A and 4B as a solid curve 400. As explained above, improving the reliability of the product or process may be achieved by “shifting” the CDF to the left (in this case, that is equivalent to decreasing the mean μ(Δγ)), as shown by dashed curve 402 in FIG. 4A, and/or by “raising” the CDF (in this case, that is equivalent to decreasing the standard distribution σ(Δγ)), as shown by dotted curve 404 in FIG. 4B. However, the range of shear strain Δγ is an output of the system and is therefore not directly controllable in the design of the product or process.

Accordingly, at 110, the parameters of the cumulative distribution function are expressed in terms of the design variables. The forms of the parameters in terms of the design variables are derived analytically from the transfer functions generated at 106.

In the BGA example above, the parameters of the cumulative distribution function are the mean μ(Δγ) and the standard distribution σ(Δγ). The mean μ(Δγ) is given in terms of the design variables by Engelmaier equation (2) above. To derive the standard distribution σ(Δγ), an additive noise model is used. Assuming an additive noise model, the location-dispersion or mean-variance model of the objective functions is:
R =ƒ(W,X,Z)+e, (5)
where
R denotes the set of outputs, i.e. shear strain range and cycles to failure;
W denotes the set of controllable variables that can be chosen by a designer;
X denotes the signal variables that drive the outputs;
Z denotes the set of observable noise/uncontrollable variables that cannot be changed by a designer, but values of which give variability to the outputs; and
the function ƒ is the deterministic mean that is obtained either from first principles of physics or from a response surface of experimental designs, and e is the random error caused by the uncontrollable noise factors whose expectation and variance are E(e)=0 and var(e)=σ²(W,X,Z), respectively.

The variation of R is the variation of e. In many cases, the variation of R is close enough to the variance of the linear approximation of R since the linear approximation of R is around the small area between its mean and variance. Thus, the output mean is the closed loop equation of the output of the engineered model, and the variance can be modeled from a linear approximation of the closed loop equation of the output.

A linear approximation based on the first order Taylor series expansion may be used to estimate the variance of e. The standard deviation of the shear strain range may therefore be written as follows, where the asterisk denotes fixed values of the random variables:

$$σ ( Δγ ) \approx \frac{ξ}{2} sqrt [ {( \frac{( {α}_{PWB}^{*} - {α}_{BGA}^{*} )}{{h}^{*}} Δ {T}^{*} \cdot σ ( L ) )}^{2} + {( \frac{{L}^{*} ( 1 - {α}_{BGA}^{*} )}{{h}^{*}} Δ {T}^{*} \cdot σ ( {α}_{PWB} ) )}^{2} + {( \frac{{L}^{*} ( {α}_{PWB}^{*} - 1 )}{{h}^{*}} Δ {T}^{*} \cdot σ ( {α}_{BGA} ) )}^{2} + {( \frac{{L}^{*} ( {α}_{PWB}^{*} - {α}_{BGA}^{*} )}{{h}^{*}} \cdot σ ( Δ T ) )}^{2} + {( \frac{{L}^{*} ( {α}_{PWB}^{*} - {α}_{BGA}^{*} )}{{h}^{* 2}} \cdot Δ T \cdot σ ( h ) )}^{2} ] \qquad ( 6 )$$

This approximation of the standard deviation of the shear strain range is just an example, and other analytical formulations relating the standard deviation of the shear strain range to the design variables are possible.

Now that the parameters of the cumulative distribution function have been expressed in terms of the design variables of the system, at 112 those design variables which are critical are identified. A design variable is critical if the reliability of the product or process is sensitive to changes in the design variable. The most sensitive design variables will most likely dictate the optimization of the reliability, which is described in more detail below. Functional Analysis of Variance (ANOVA) sensitivity analysis may be used to identify the critical design variables.

For the BGA example above, functional ANOVA sensitivity analysis may be used, following the teachings in Sobol, I. M., “Global sensitivity indices for non-linear mathematical models and their Monte Carlo estimates”, Mathematics and Computers in Simulation, vol. 55, pp. 271-280.

The total effect of a design variable xⱼ on the total output variability is calculated from the forms of the parameters μ and σ obtained at 110, as derived in detail in Appendix A.

The total effect of xⱼ to the total output variability is given by

$$T S ( j ) = 1 - \frac{{D}_{\sim j}}{D} , \qquad ( 7 )$$

where D_{˜j} is the sum of variance of all of the S_{ij . . . k} terms that do not include xⱼ, i.e., the total fractional variance complement to xⱼ. The effective number of design variables, K, for K≦M, relative to the product performance, may be determined by applying cut-off criteria such as the following:

$${\sum }_{j ∈ J} T S ( j ) \geq p {\sum }_{j = 1}^{M} T S ( j ) \qquad ( 8 )$$

where 0≦p≦1 is the cut-off value and J is a subset of design variables with the largest total sensitivity to the product performance such that the inequality above is satisfied for a given p. K is the number of effective or critical design variables in the subset J.

Tables 1 and 2 show the total influence of the design variables and interactions therebetween on the mean μ(Δγ) of the shear strain range and the standard deviation σ(Δγ) of the shear strain range, respectively.

TABLE 1
Percentage effect of design variables xᵢ and interactions on μ(Δγ)

| | | | | | Total | Total |
|---|---|---|---|---|---|---|
| xᵢ | Sum of Squares | Sᵢ % | TS(i) % | Adj. TS(i) % | Main effect | interaction |
| L | 7.93E−04 | 29.77 | 36.42 | 33.03 | 90.14 | 9.86 |
| h | 7.85E−04 | 29.46 | 36.08 | 32.72 | | |
| α_{PWB} | 5.11E−04 | 19.18 | 23.38 | 21.20 | | |
| α_{BGA} | 3.12E−04 | 11.72 | 14.36 | 13.03 | | |
| ΔT | 5.00E−07 | 0.02 | 0.03 | 0.02 | | |
| L · h | 8.22E−05 | 3.08 | | | | |
| L · α_{PWB} | 5.35E−05 | 2.01 | | | | |
| L · α_{BGA} | 3.27E−05 | 1.23 | | | | |
| L · ΔT | 1.00E−07 | 0.00 | | | | |
| h · α_{PWB} | 5.29E−05 | 1.98 | | | | |
| h · α_{BGA} | 3.23E−05 | 1.21 | | | | |
| h · ΔT | 1.00E−07 | 0.00 | | | | |
| L · h · α_{PWB} | 5.50E−06 | 0.21 | | | | |
| L · h · α_{BGA} | 3.40E−06 | 0.13 | | | | |
| Total | 2.67E−03 | 100.00 | 110.27 | 100.00 | | |

TABLE 2
Percentage effect of design variables xᵢ and interactions on σ(Δγ)

| | | | | | Total Main | Total |
|---|---|---|---|---|---|---|
| xᵢ | Sum of Squares | Sᵢ % | TS(i) % | Adj. TS(i) % | effect | interaction |
| L | 338.28 | 21.53 | 28.89 | 25.33 | 87.62 | 11.82 |
| h | 843.81 | 53.69 | 64.84 | 56.85 | | |
| α_{PWB} | 121.80 | 7.75 | 12.19 | 10.69 | | |
| α_{BGA} | 72.96 | 4.64 | 7.55 | 6.62 | | |
| ΔT | 0.20 | 0.01 | 0.57 | 0.50 | | |
| L · h | 87.70 | 5.58 | | | | |
| L · α_{PWB} | 12.05 | 0.77 | | | | |
| L · α_{BGA} | 7.24 | 0.46 | | | | |
| h · α_{PWB} | 49.02 | 3.12 | | | | |
| h · α_{BGA} | 29.76 | 1.89 | | | | |
| other | 8.71 | 0.55 | | | | |
| interactions | | | | | | |
| Total | 2.67E−03 | 100.00 | 110.27 | 100.00 | | |

The results in Tables 1 and 2 indicate that the controllable variables L, h, α_{PWB} and α_{BGA} are critical to the mean and standard deviation of the shear strain range, while the uncontrollable variable ΔT is not critical. Looking at the third column from the right, changes to L, h and α_{PWB} will have an effect of approximately 85% on the mean of the shear strain range, and changes to L and h will have an effect of approximately 80% on the standard deviation of the shear strain range. Consequently, design efforts focused on the controllable variables L and h may have the greatest effect on the reliability.

Once the critical variables have been identified at 112, it is checked, at 114, whether it is feasible to control any of those critical variables. For example, it is generally difficult and expensive to control the coefficient of thermal expansion of the PWB. If it is not feasible to control the critical variables, or if none of the critical variables are controllable variables, then the method is stopped at 116, and a different approach may be needed in order to improve the reliability of the product or process.

If however, it is feasible to control at least one of the critical variables, then the method continues at 118, where it is determined what effect changes in each of the critical variables will have on the cumulative distribution function.

In the additive noise model, shifting the CDF is equivalent to minimizing the locations (mean), and raising the CDF is equivalent to squeezing/minimizing the dispersion (standard deviation). Shifting may be achieved by setting values of controllable variables that have a linear relation to the output and that do not have any interaction with noise/uncontrollable variables. Raising may be achieved by setting values of controllable variables that have a nonlinear relation to the output or have interaction with noise/uncontrollable variables. To determine whether the design variables have a linear relation to the output and whether there is an interaction between design variables and noise/uncontrollable variables, calculations may be made using the transfer functions.

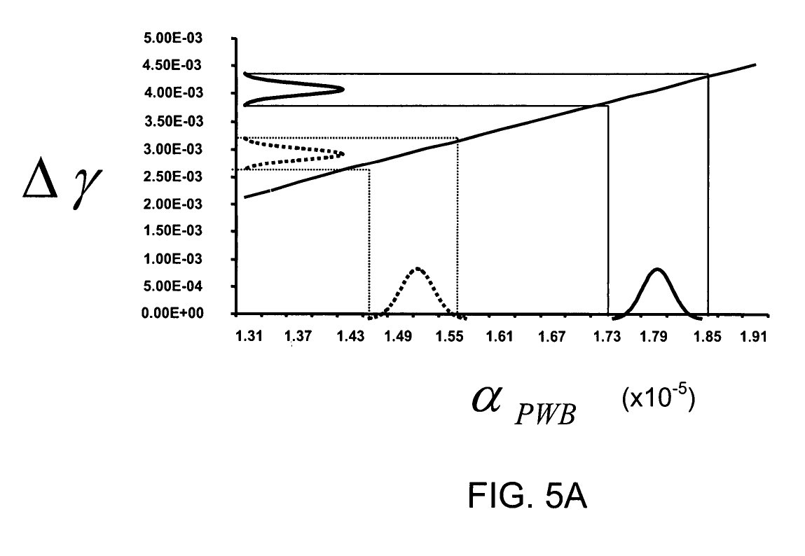

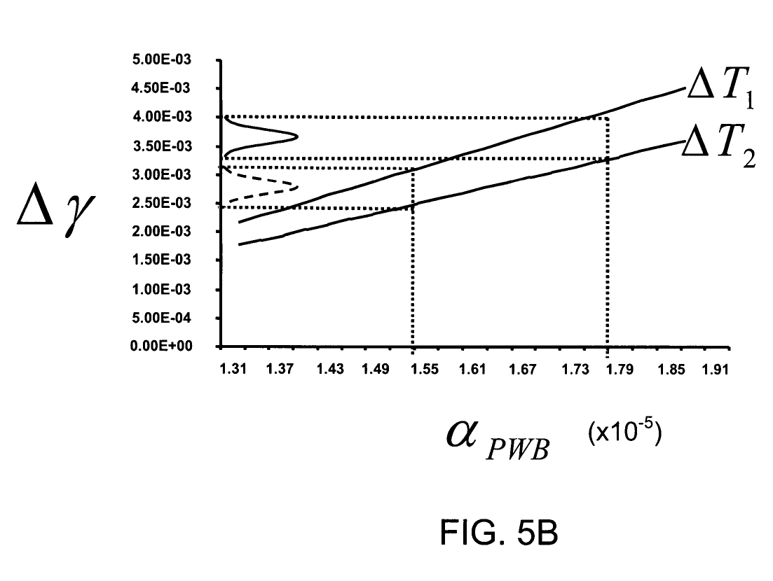

FIG. 5A is an exemplary mapping of Δγ versus α_{PWB} calculated from Engelmaier equation (2) with fixed values for all design variables except α_{PWB}. The controllable variable α_{PWB}, given values in a first range and a second, higher, range, has a linear relation with the output shear strain range Δγ. FIG. 5B is an exemplary mapping of Δγ versus α_{PWB}, calculated from Engelmaier equation (2) with fixed values for all design variables except ΔT and α_{PWB}. Two different values of ΔT are used in the calculation (ΔT₁ and ΔT₂), as are two different values of α_{PWB}. The controllable variable α_{PWB} does not interact with the noise variable ΔT. Increasing the value of α_{PWB}, while keeping all other variables fixed, increases the mean of the shear strain range μ(Δγ) and has no effect on the standard deviation of the shear strain range σ(Δγ). Consequently, the level of the controllable variable α_{PWB} may be changed to shift the CDF without affecting variability.

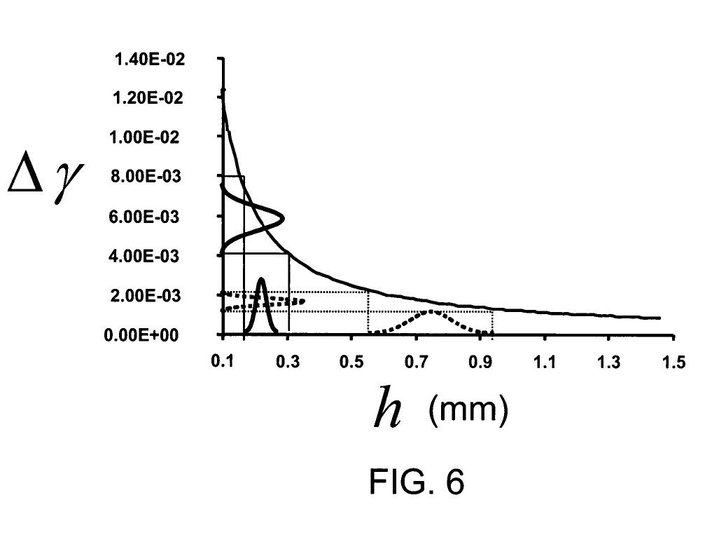

FIG. 6 is an exemplary mapping of α_{PWB} versus h, calculated from Engelmaier equation (2) with fixed values for all design variables except h. The controllable variable h, given values in a first range and a second, higher, range, has a nonlinear relation with the output shear strain range Δγ. The product is more robust at high values of h than at low values of h, when all other variables are fixed.

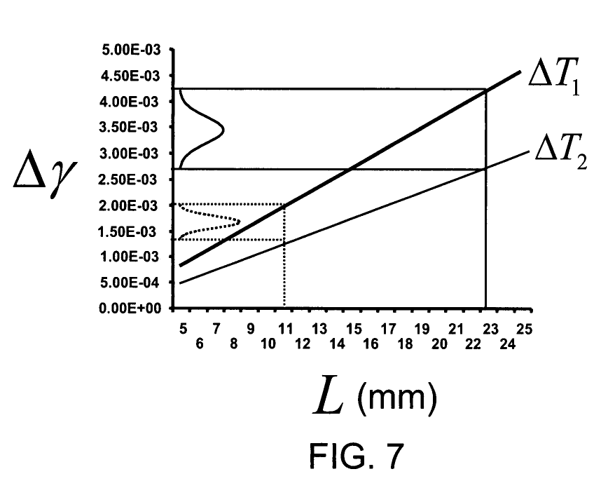

FIG. 7 is an exemplary mapping of the Δγ versus L, calculated from Engelmaier equation (2) with fixed values for all design variables except ΔT and L. Two different values of ΔT are used in the calculation (ΔT₁ and ΔT₂), as are two different values of L. The controllable variable L has an interaction with the noise variable ΔT. The product is more robust with respect to changes in ΔT at low values of L than at high values of L, when all other variables are fixed.

Since controllable variable h has a nonlinear relation to the shear strain range Δγ and controllable variable L interacts with the noise variable ΔT, the nominal value of the variables h and L may have a major effect on the variability of the shear strain range. Changing the levels of these controllable variables may desensitize the response of the shear strain range to variability in the controllable variables. The levels of these controllable variables may be set to raise the CDF and make the product more robust. For example, as shown in FIG. 6, the variability of h is greater at higher values of h than at lower values of h, yet the variability in the shear strain range is lower at higher values of h than at lower values of h.

At 120, the optimization of the reliability is performed with respect to one or more of the critical controllable variables. If all of the controllable variables have linear relations with the output and no interactions with the noise variables, then only shifting of the CDF is possible, and a single-objective optimization is performed. Otherwise, shifting and raising the CDF are possible, and a multiple-objective optimization is performed.

There are several different approaches to optimization. Both a graphical approach and a desirability-function approach are described below.

For the BGA example above, an experimental simulation was performed as follows. The values of the controllable variables L, h, α_{PWB} and α_{BGA}, and of the noise variable ΔT were varied, while the standard deviation of these variables was fixed. The values used in the simulation were as follows:

| Controllable | | | Maximum |
|---|---|---|---|
| Variables | Minimum Value | Intermediate Value | Value |
| L [mm] | 10.9 | 16.2 | 24.4 |
| h [mm] | 0.38 | 0.567 | 0.85 |
| α_{PWB} [ppm/° C.] | 13.1 | 14.5 | 18.1 |
| α_{BGA} [ppm/° C.] | 5 | 7.50 | 9.00 |

| Noise Variables | Fixed value |
|---|---|
| σ(L) [mm] | 0.0265 |
| σ(h) [mm] | 0.0052 |
| σ(α_{PWB}) [ppm/° C.] | 0.0072 |
| σ(α_{BGA}) [ppm/° C.] | 0.0022 |

where the standard deviation values were derived from Evans, J. W. et al., “Simulation of Fatigue Distributions for Ball Grid Arrays by the Monte Carlo Method”, Microelectronics Reliability, vol. 40, no. 7, August 2000, pp. 1147-1155. The difference in temperature ΔT between the PWB and BGA was set to 39.6° C., 40.0° C., and 40.0° C., and the empirical correction factor ξ was set to 0.54.

The results of the simulation included the following:

| | | | α_{PWB} | α_{BGA} | | | |
|---|---|---|---|---|---|---|---|
| Run # | L [mm] | h [mm] | [ppm/° C.] | [ppm/° C.] | ΔT [° C.] | μ(Δγ) | σ(Δγ) |
| 1 | 10.9 | 0.380 | 13.1 | 5.0 | 39.6 | 2.48E−03 | 3.53E−05 |
| 2 | 10.9 | 0.380 | 13.1 | 5.0 | 40.0 | 2.51E−03 | 3.56E−05 |
| 3 | 10.9 | 0.380 | 13.1 | 5.0 | 40.4 | 2.53E−03 | 3.60E−05 |
| 119 | 16.2 | 0.567 | 14.5 | 7.5 | 39.6 | 2.14E−03 | 2.12E−05 |
| 120 | 16.2 | 0.567 | 14.5 | 7.5 | 40.0 | 2.16E−03 | 2.14E−05 |
| 121 | 16.2 | 0.567 | 14.5 | 7.5 | 40.4 | 2.18E−03 | 2.16E−05 |
| 241 | 24.4 | 0.850 | 18.1 | 9.0 | 39.6 | 2.79E−03 | 1.88E−05 |
| 242 | 24.4 | 0.850 | 18.1 | 9.0 | 40.0 | 2.82E−03 | 1.90E−05 |
| 243 | 24.2 | 0.850 | 18.1 | 9.0 | 40.4 | 2.85E−03 | 1.92E−05 |

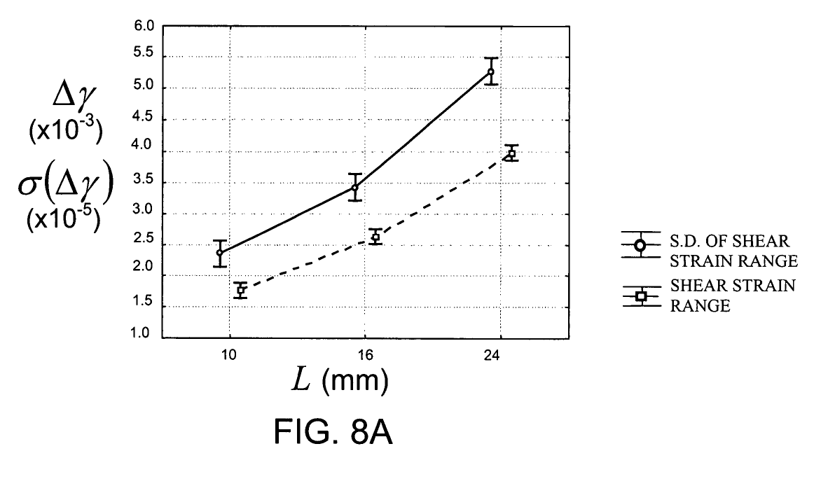

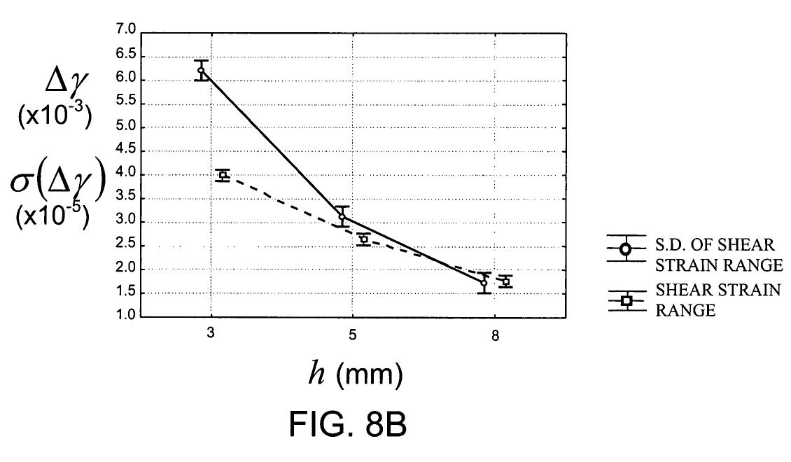

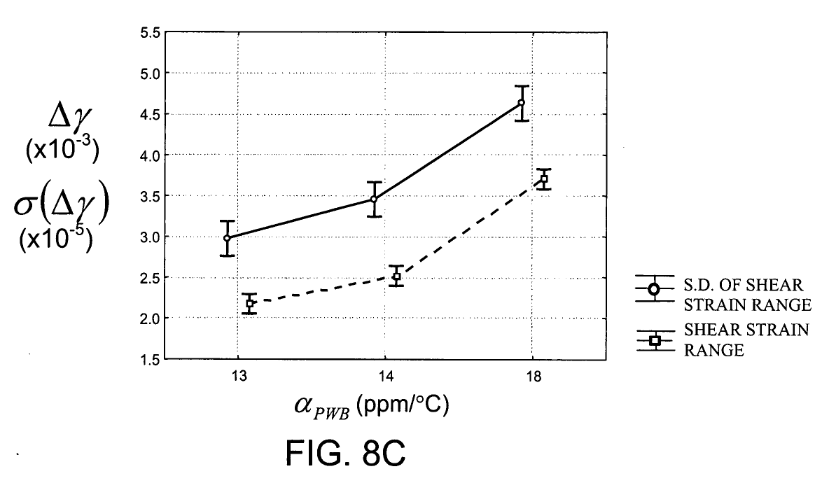

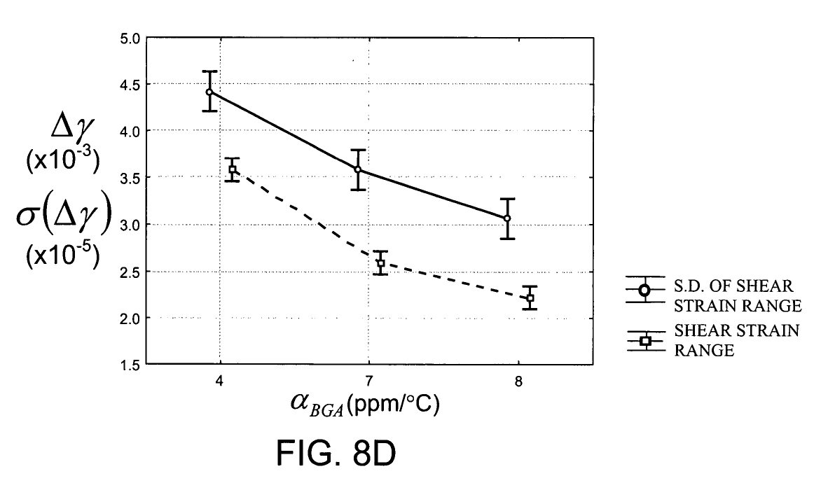

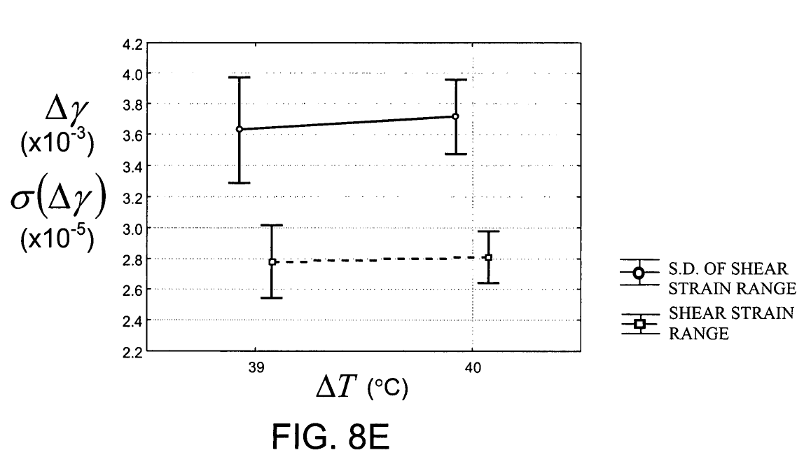

The results of the experimental simulation may also be viewed graphically. FIGS. 8A, 8B, 8C, 8D and 8E are plots of μ(Δγ) (solid line) and σ(Δγ) (dashed line) as a function of L, h, α_{PWB}, α_{BGA} and ΔT, respectively. In this example, changes of the variable values result in changes in μ(Δγ) and σ(Δγ), but the changes are in the same direction. Therefore, to minimize μ(Δγ) and σ(Δγ), one should minimize L, maximize h, minimize α_{PWB} and maximize α_{BGA}. If, however, changes in a design variable were to cause opposite changes in μ(Δγ) and σ(Δγ), then one would need to trade-off the minimization of μ(Δγ) and σ(Δγ) with respect to that design variable.

Plots of μ(Δγ) as a function of h and L, α_{PWB} and L, α_{PWB} and h, α_{BGA} and L, α_{BGA} and h, and α_{PWB} and α_{BGA}, although not shown here, demonstrate that there are no significant effects on μ(Δγ) due to interactions between the tested variables. Consequently, using the graphical approach, the optimal solution with respect to the critical controllable variables L, h, α_{PWB} and α_{BGA} is L=10.9 mm, h=0.85 mm, α_{PWB}=13.1 ppm/° C. and α_{BGA}=9.0 ppm/° C.

An exemplary desirability-function approach to optimizing the reliability is as follows. The multiple objectives of the optimization are to minimize μ(Δγ) and σ(Δγ), subject to the following constraints:

10.90 mm=L_{MIN}≦\hat{L}≦L_{MAX}=24.40 mm;

0.38 mm=h_{MIN}≦ĥ≦h_{MAX}=0.85 mm;

13.1 ppm/° C.=α_{PWB MIN}≦\hat{α}_{PWB}≦α_{PWB MAX}=18.1 ppm /° C.;

4.96 ppm/° C.=α_{BGA MIN}≦\hat{α}_{BGA}≦α_{BGA MAX}=8.95 ppm/° C.; and

39.6° C.=ΔT_{MIN}≦Δ\hat{T}≦ΔT_{MAX}=40.4° C.,

where the caret denotes the value of the design variable that optimizes the reliability.

Since the scale of the responses μ(Δγ) and σ(Δγ) differ, a normalized individual desirability di factor is defined for each response, as follows:

$${d}_{i} = \{ \begin{matrix} 1 , & if {y}_{i} \leq {y}_{i}^{min\_target} \\ {[ \frac{{y}_{i}^{max\_target} - {y}_{i}}{{y}_{i}^{max\_target} - {y}_{i}^{min\_target}} ]}^{V} , & if {y}_{i}^{min\_target} \leq {y}_{i} \leq {y}_{i}^{max\_target} \\ 0 , & if {y}_{i} \geq {y}_{i}^{max\_target}\end{matrix} \qquad ( 9 )$$

where yᵢ represents values of μ(Δγ) and σ(Δγ), yᵢ^{max}^{_{—}}^{target} and yᵢ^{min}^{_{—}}^{target} are upper and lower target values of the response, and V is an exponential shape parameter. For example, it may be determined that the target values of μ(Δγ) are between 2.4×10⁻³ and 2.6×10⁻³. Therefore, the normalized individual desirability dᵢ factor for μ(Δγ) will have a value of 1 if μ(Δγ)≦2.4×10⁻³, a value of 0 if μ(Δγ)≧2.6×10⁻³, and a value between 0 and 1 according to the formula above if μ(Δγ) is between 2.4×10⁻³ and 2.6×10⁻³. Similarly, upper and lower target values may be determined for σ(Δγ).

Weighted geometric mean aggregate methods may be used to combine the normalized individual desirability factors into a combined desirability D. For example, D may be defined as follows:

$$D = {( {d}_{1}^{{w}_{1}} \times {d}_{2}^{{w}_{2}} \times … \times {d}_{n}^{{w}_{n}} )}^{1 / {\sum }_{i = 1}^{n} {w}_{i}} \qquad ( 10 )$$

where n is the total number of responses (n=2 in this example) and wᵢ is the weight of normalized individual desirability dᵢ. Optimizing the multiple responses is equivalent to maximizing the combined desirability D.

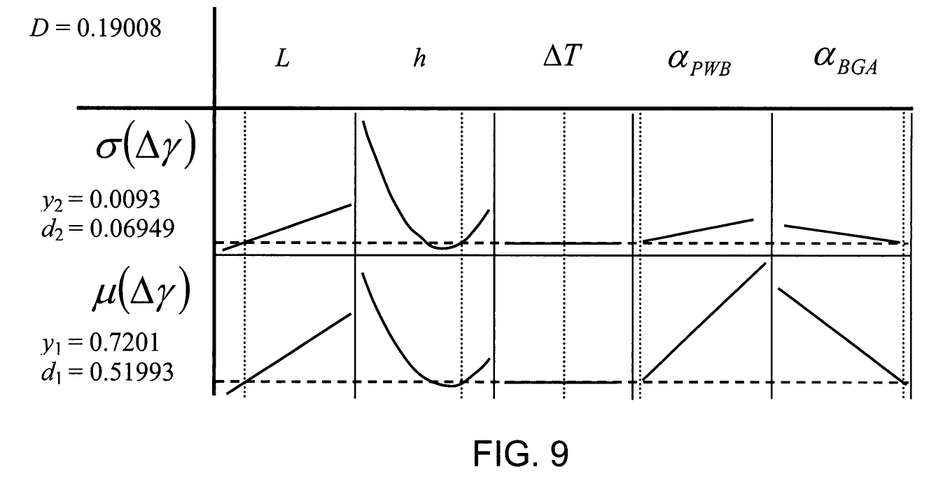

A calculation of the optimal combined desirability D was performed (with weights of 1) and resulted in an optimal desirability D=0.19008, with normalized individual desirabilities of d₁=0.51993 for μ(Δγ) and d₂=0.06949 for σ(Δγ). The results of the calculation are plotted in FIG. 9. The solid lines and curves are plots of μ(Δγ) and σ(Δγ) as a function of each of the design variables L, h, ΔT, α_{PWB} and α_{BGA}. The horizontal dashed lines mark the optimal response value y₁=103×μ(Δγ)=0.7201 and the optimal response value y₂=103×σ(Δγ)=0.0093. The vertical dotted lines mark the optimal values of the controllable variables according to the desirability-function approach: \hat{L}=13.0 mm, ĥ=0.75 mm, \hat{α}_{PWB}=13.1 ppm/° C. and \hat{α}_{BGA}=8.9 ppm/° C., and indicate that this optimal desirability D occurs at ΔT=40.0 ° C., although ΔT is an uncontrollable noise variable.

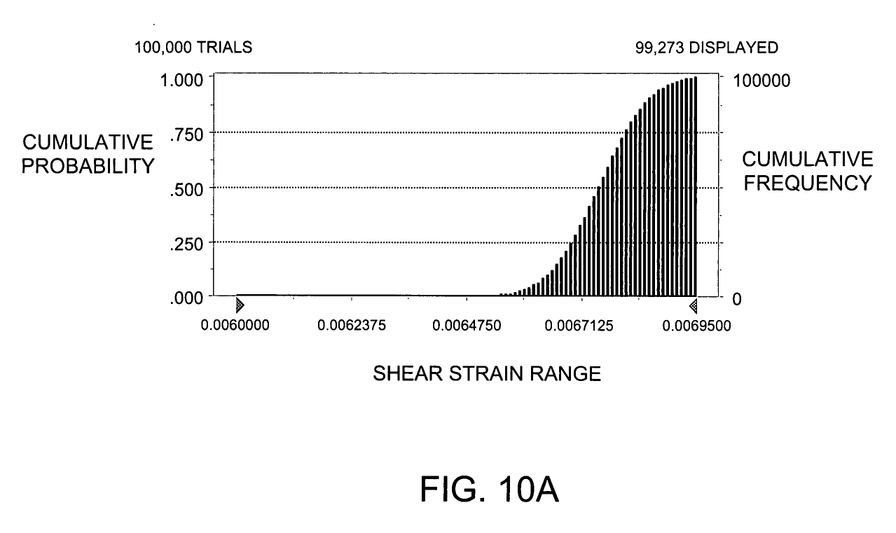

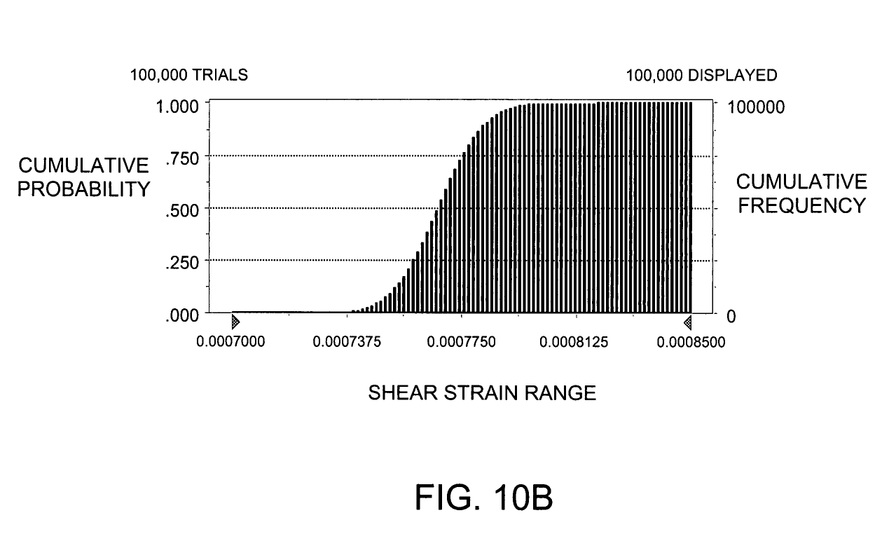

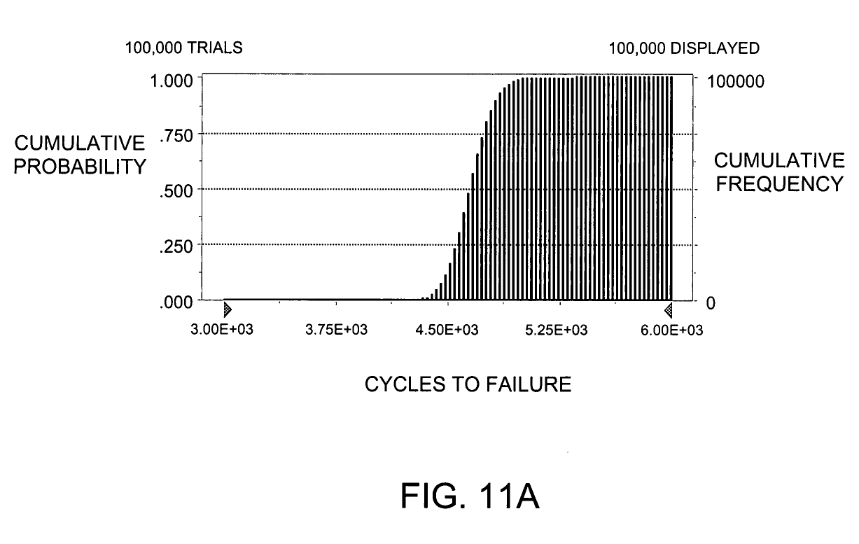

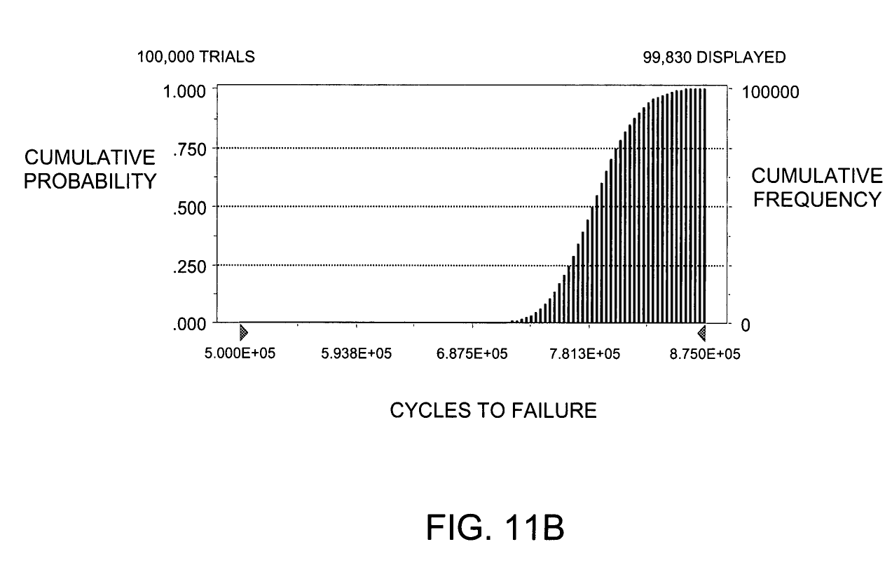

FIGS. 10A, 10B, 11A and 11B show comparisons of a “Setting 1 ” of non-optimal values and a “Setting 2 ” of optimal values for the controllable variables resulting from the desirability calculation above.

Mean Values

| Variables | Setting 1 | Setting 2 |
|---|---|---|
| L [mm] | 16.2 | 13 |
| h [mm] | 0.56 | 0.75 |
| α_{PWB} [ppm/° C.] | 14.5 | 13.1 |
| α_{BGA} [ppm/° C.] | 7.5 | 8.9 |
| ΔT [° C.] | 40 | 40 |

FIGS. 10A and 10B are graphs of a cumulative distribution function as a function of shear strain range in Setting 1 and Setting 2, respectively. The CDF of FIG. 10B has a significantly lower mean and a smaller dispersion than those of the CDF of FIG. 10A. So the CDF of figure 10B is “shifted” to the left and “raised” relative to the CDF of FIG. 10A. Since higher values of shear strain range are related to higher rates of failure, the optimal values of Setting 2 represent an improvement in reliability relative to the non-optimal values of Setting 1.

FIGS. 11A and 11B are graphs of a cumulative distribution function as a function of the number of cycles to failure for the non-optimal values and the optimal values, respectively. The CDF of FIG. 11B has a significantly higher mean and a higher dispersion than those of the CDF of FIG. 11A. So the CDF of FIG. 11B is “shifted” to the right and “lowered” relative to the CDF of FIG. 11A. Since higher numbers of cycles to failure are related to lower rates of failure, the optimal values represent an improvement in reliability relative to the non-optimal values.

Using the formulation of the reliability in terms of the CDF (performed at 108), reliability predictions for Setting 1 (non-optimal values) and Setting 2 (optimal values) may be compared. The results for the BGA example above were as follows:

| Setting 1 | | | Setting 2 | | |
|---|---|---|---|---|---|
| | P(Δγ ≦ | Cycles- | | P(Δγ ≦ | Cycles- |
| Y | Y) | to-failure | Y | Y) | to-failure |
| 2.22E−03 | 0.01 | 6.402E+04 | 8.14E−04 | 0.01 | 6.855E+05 |
| 2.20E−03 | 0.05 | 6.529E+04 | 8.06E−04 | 0.05 | 7.016E+05 |
| 2.19E−03 | 0.10 | 6.598E+04 | 8.01E−04 | 0.10 | 7.105E+05 |
| 2.18E−03 | 0.20 | 6.682E+04 | 7.96E−04 | 0.20 | 7.214E+05 |
| 2.17E−03 | 0.30 | 6.744E+04 | 7.92E−04 | 0.30 | 7.295E+05 |
| 2.17E−03 | 0.40 | 6.798E+04 | 7.89E−04 | 0.40 | 7.364E+05 |
| 2.16E−03 | 0.50 | 6.849E+04 | 7.86E−04 | 0.50 | 7.430E+05 |
| 2.15E−03 | 0.60 | 6.900E+04 | 7.83E−04 | 0.60 | 7.497E+05 |
| 2.15E−03 | 0.70 | 6.956E+04 | 7.80E−04 | 0.70 | 7.570E+05 |
| 2.14E−03 | 0.80 | 7.022E+04 | 7.76E−04 | 0.80 | 7.656E+05 |
| 2.13E−03 | 0.90 | 7.114E+04 | 7.71E−04 | 0.90 | 7.777E+05 |
| 2.12E−03 | 0.95 | 7.192E+04 | 7.67E−04 | 0.95 | 7.880E+05 |
| 2.10E−03 | 0.99 | 7.342E+04 | 7.59E−04 | 0.99 | 8.078E+05 |

With the design variables at non-optimal Setting 1, the mean shear strain range is μ(Δγ)=2.16E−03, the standard deviation of the shear strain range is σ(Δγ)=2.69E−05, and the probability of a product to have:

shear strain range>2.10E−03 or cycles-to-failure>73,420 is 99%

shear strain range>2.16E−03 or cycles-to-failure>68,490 is 50%

shear strain range>2.20E−03 or cycles-to-failure>65,290 is 5%

shear strain range>2.22E−03 or cycles-to-failure>64,020 is 1%

With the design variables at optimal Setting 2, the mean shear strain range is μ(Δγ)=7.68E−04, the standard deviation of the shear strain range is σ(Δγ)=1.18E−05, and the probability of a product to have:

shear strain range>7.59E−04 or cycles-to-failure>807,800 is 99%

shear strain range>7.86E−04 or cycles-to-failure>743,000 is 50%

shear strain range>8.06E−04 or cycles-to-failure>701,600 is 5%

shear strain range>8.14E−04 or cycles-to-failure>685,500 is 1%

μ(Δγ) and σ(Δγ) of Setting 2 are approximately 2.29 times and 2.75 times smaller than those of Setting 1, respectively. An improvement of close to 3 times in the mean and standard deviation of the shear strain range yields improvements of more than 10 times in the cycles-to-failure of the product.

At 122, the design involving the optimal values for the critical controllable variables calculated at 120 is validated with hardware implementations. If the analytical findings are in line with the physical tests, then the design is reliable, as at 124. If the hardware implementations deviate from what the analytical findings predicted, then if the deviation is major (checked at 126), the modeling of the product or process at 104 may need to be revised. If the deviation is minor, then the optimization effort at 118 and 129 may need to be revised so that more appropriate settings for the design variables are chosen. A test may be performed through the inverse of the cumulative distribution function at the tail or critical area. For example, a test may be done for the probability of failures at 1% with a much smaller number of samples.

While the optimal values for the critical controllable variables are calculated at 120, that calculation does not quantify the effect of variations in those variables from the optimal values on the reliability. At 128, the sensitivity of the reliability to the uncontrollable variables (e.g. ΔT) and to variations of the critical controllable variables (e.g. L, h, α_{PWB} and α_{BGA}) in the vicinity of their optimal values may optionally be determined. For example, this sensitivity may be determined via local probabilistic sensitivity analysis based on root sum of squares techniques, or tolerance design-based functional ANOVA analysis.

For the BGA example above, the standard deviation σ(Δγ) of the shear strain range around the mean μ(\hat{x}₁), . . . , μ(\hat{x}₅) (where x₁, . . . , x₅ are the variables L, h, ΔT, α_{PWB} and α_{BGA}) based on the first-order Taylor series expansion is known as the Root Sum of Squares (RSS) formula:

$$σ ( Δγ ) = \sqrt{{\sum }_{i = 1}^{M} {( \frac{\partial f ( x )}{\partial {x}_{i}} {\vert}_{x = μ ( {\hat{x}}_{1} ) , … , μ ( {\hat{x}}_{5} )} σ ( {x}_{i} ) )}^{2}} . \qquad ( 11 )$$

The local probabilistic sensitivity, importance, influence or contribution of xᵢ around μ(\hat{x}₁), . . . , μ(\hat{x}₅) is as follows:

$$S ( {x}_{i} ) = \frac{{( \frac{\partial f ( x )}{\partial {x}_{i}} {\vert}_{x = μ ( {\hat{x}}_{1} ) , … , μ ( {\hat{x}}_{5} )} σ ( {x}_{i} ) )}^{2}}{{σ}^{2} ( Δγ )} . \qquad ( 12 )$$

This is the influence of a certain variable xᵢ on a certain design setting (fixed variable values and tolerances). “Probabilistic” sensitivity has two components:
a) Sensitivity of the performance function to the variable,

$$\frac{\partial f ( x )}{\partial {x}_{i}} .$$
ƒ is a generic function for the response, which in the BGA example above is the shear strain range and the standard deviation of the shear strain range. It is the slope of the function at the point of interest (for example, the mean value) with respect to variable xᵢ.
b) Variability of the variable: σ²(xᵢ), for example, spread or dispersion that may be due to unit-to-unit variation, degradation, and/or other factors.

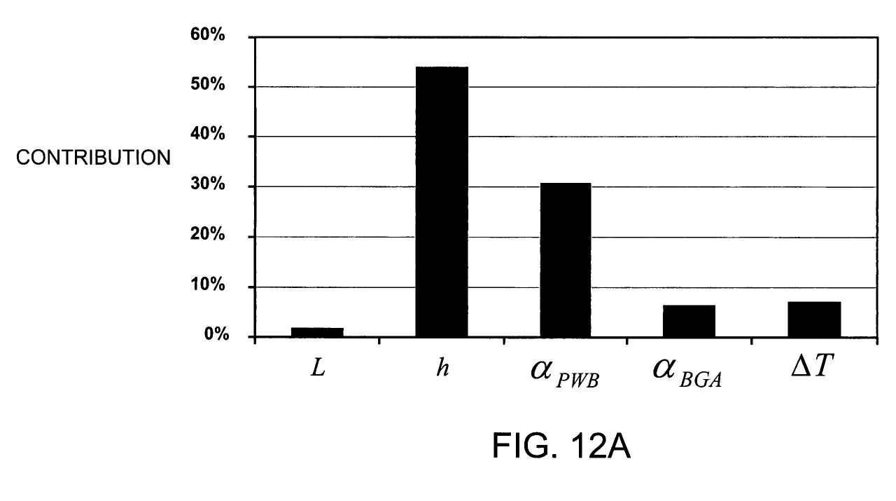

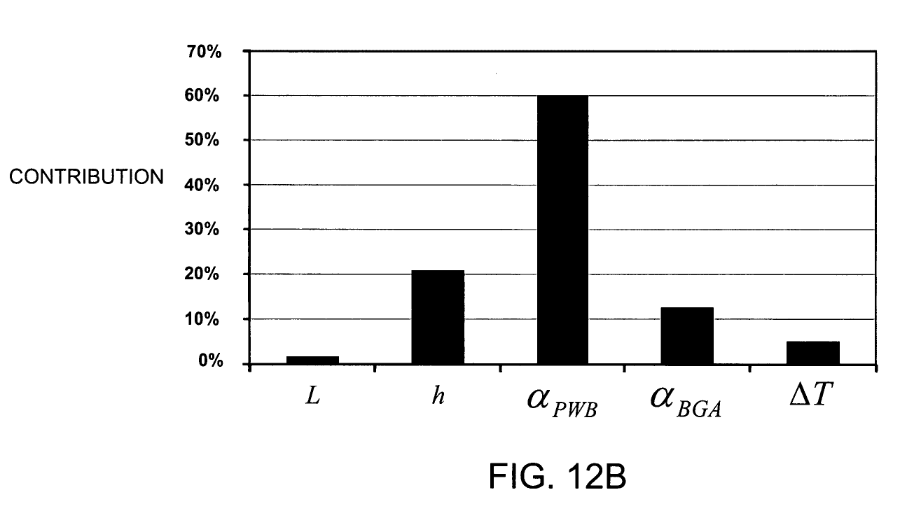

FIGS. 12A and 12B are bar graphs of the percent contribution of design variables to the standard deviation σ(Δγ) in Setting 1 and Setting 2, respectively. The plots show that h and α_{PWB} are critical variables. Quality assurance may be focused on these factors when inspecting products. Manufacturers may focus on these factors when planning the facility and tooling.

Another way to rank the sensitivity of the design variables is to apply functional ANOVA to simulations in which the design variables have fixed values and the tolerance of the design variables changes. The values used in the simulation were as follows:

| | Mean Values | | Standard Deviation | | | | |
|---|---|---|---|---|---|---|---|
| Variables | Set. 1 | Set. 2 | B − 50% B | B − 25% B | Baseline (B) | B + 50% B | B + 100% B |
| L [mm] | 16.2 | 13 | 1.33E−02 | 1.99E−02 | 2.65E−02 | 3.98E−02 | 5.30E−02 |
| h [mm] | 0.56 | 0.75 | 2.60E−03 | 3.90E−03 | 5.20E−03 | 7.80E−03 | 1.04E−02 |
| α_{PWB} | 14.5 | 13 | 2.42E−08 | 3.62E−08 | 4.83E−08 | 7.25E−08 | 9.66E−08 |
| [ppm/° C.] | | | | | | | |
| α_{BGA} | 7.5 | 8.9 | 1.11E−08 | 1.67E−08 | 2.22E−08 | 3.33E−08 | 4.44E−08 |
| [ppm/° C.] | | | | | | | |
| ΔT [° C.] | 40 | 40 | 6.50E−02 | 9.75E−02 | 1.30E−01 | 1.95E−01 | 2.60E−01 |

Tables 3 and 4 show the sensitivity of the design variables and interactions therebetween for Setting 1 and 2, respectively, where all the standard deviation numbers have been multiplied by 10⁵.

TABLE 3
Percentage effect of tolerance of design variables xᵢ and interactions on σ(Δγ)

| | | | | | Total Main | Total |
|---|---|---|---|---|---|---|
| Setting 1 | Sum of Squares | Sᵢ % | TS(i) % | Adj. TS(i) % | effect | interaction |
| σ(L) | 2.28 | 0.09 | 0.40 | 0.40 | 98.64 | 1.36 |
| σ(h) | 1888.62 | 70.53 | 71.90 | 71.25 | | |
| σ(α_{PWB}) | 677.73 | 25.31 | 26.67 | 26.43 | | |
| σ(α_{BGA}) | 34.67 | 1.29 | 1.61 | 1.60 | | |
| σ(ΔT) | 37.81 | 1.41 | 0.32 | 0.32 | | |
| σ(h) · σ(α_{PWB}) | 27.97 | 1.04 | | | | |
| other | 8.52 | 0.32 | | | | |
| interactions | | | | | | |
| Total | 2677.6 | 100.00 | 100.91 | 100.00 | | |

TABLE 4
Percentage effect of tolerance of design variables xᵢ and interactions on σ(Δγ)

| | | | | | Total Main | Total |
|---|---|---|---|---|---|---|
| Setting 2 | Sum of Squares | Sᵢ % | TS(i) % | Adj. TS(i) % | effect | interaction |
| σ(L) | 0.585 | 0.11 | 0.91 | 0.89 | 98.59 | 1.41 |
| σ(h) | 61.511 | 11.67 | 13.08 | 12.67 | | |
| σ(α_{PWB}) | 429.709 | 81.52 | 82.93 | 80.37 | | |
| σ(α_{BGA}) | 24.549 | 4.66 | 5.46 | 5.29 | | |
| σ(ΔT) | 3.346 | 0.63 | 0.80 | 0.78 | | |
| σ(h) · σ(α_{PWB}) | 3.174 | 0.60 | | | | |
| other | 4.237 | 0.80 | | | | |
| interactions | | | | | | |
| Total | 527.111 | 100.00 | 103.18 | 100.00 | | |

The results in Tables 3 and 4 indicate that the tolerances of the controllable variables h and α_{PWB}are critical (>90% influence). The tolerance of the shear strain range σ(Δγ) is sensitive to changes in the tolerances of h and α_{PWB}.

While the BGA example above demonstrates how to apply the methodology of embodiments of the invention to a product, the embodiments are equally applicable to a process that is being designed or redesigned.

For example, it may be beneficial to improve the performance of a process involving a trim press machine. The process may be modeled as having controllable variables including, for example, head size, press time, pressure, with or without a glove, different procedures to place the trim, and uncontrollable variables including, for example, the adhesive content of the material, the surface of the device to be pressed, and the like, and noise variables including, for example, humidity and temperature. The transfer function of the press performance may be derived from a design of experiments (DOE). The rest of the methodology of FIG. 1, as described above, may be applied to the process.

While certain features of the invention have been illustrated and described herein, many modifications, substitutions, changes, and equivalents will now occur to those of ordinary skill in the art. It is, therefore, to be understood that the claims that follow Appendix A are intended to cover all such modifications and changes as fall within the spirit of the invention.

### APPENDIX A

### Functional ANOVA Sensitivity Analysis

The following derivation is based on the teachings in Sobol, I. M., “Global sensitivity indices for non-linear mathematical models and their Monte Carlo estimates”, Mathematics and Computers in Simulation, vol. 55, pp. 271-280.

The forms of the parameters μ and σ obtained at 110 may be decomposed into independent (orthogonal) functions of increasing dimensionality:

$$\begin{matrix}f ( {x}_{1} , {x}_{2} , … , {x}_{M} ) = {f}_{0} + {\sum }_{i = 1}^{M} {f}_{i} ( {x}_{i} ) + {\sum }_{1 \leq i < j \leq M} {f}_{ij} ( {x}_{i} , {x}_{j} ) + … + \\ {f}_{12 … M} ( {x}_{1} , {x}_{2} , … , {x}_{M} )\end{matrix} \qquad ( A1 )$$

where ƒ₀ is constant and the integrals of every independent function, ƒ_{ij . . . k}(xᵢ,xⱼ, . . . , xₖ) for 1≦i<j< . . . <k≦ M and k=1, . . . , M, over any of its own variables are equal to zero.

Squaring and integrating the decomposition equation (A1), and by the orthogonality property of the terms, one obtains:

$$D = {\sum }_{i = 1}^{M} {D}_{i} + {\sum }_{1 \leq i < j \leq M} {D}_{ij} + … + {D}_{12 … M} \qquad ( A2 )$$

where D is the total variability of ƒ(x₁, . . . , x_{M}) and D_{ij . . . k} are the partial variability computed from each of the terms in the decomposition equation (A1).

The global sensitivity index is the ratio of partial variability to the total variability:

$${S}_{ij… k} = \frac{{D}_{ij… k}}{D} for 1 \leq i < j < … < k \leq M .$$

Sᵢ, the first-order sensitivity index for factor xᵢ, measures the fractional contribution of xᵢ to the variability of ƒ(x₁, . . ., x_{M}). Sᵢⱼ, for i≠j, is the second-order sensitivity index and measures the interaction effect between xᵢ and xⱼ that cannot be explained by the sum of the individual effects of xᵢ and xⱼ, and so on. The sum of all terms of the global sensitivity index is 1:

$${\sum }_{i = 1}^{M} {S}_{i} + {\sum }_{1 \leq i < j \leq M} {S}_{ij} + … + {S}_{12 … M} = 1. \qquad ( A3 )$$

The measure of total individual influence of all controllable variables, including the interaction effects among them, is calculated by partitioning x into x_{˜j} (all controllable variables excluding xⱼ) and xⱼ. The total effect of xⱼ to the total output variability is given by

$$TS ( j ) = 1 - \frac{{D}_{∼ j}}{D} , \qquad ( A4 )$$

where D_{˜j} is the sum of variance of all of the S_{ij . . . k} terms that do not include xⱼ, i.e., the total fractional variance complement to xⱼ.

What is claimed is:

1. A method to improve the reliability of a product or process, the method comprising:
optimizing a cumulative distribution function that represents the reliability, by determining optimal mean values for selected one or more critical probabilistic controllable variables of the product or process,
wherein the selected one or more variables are chosen from all of the critical probabilistic controllable variables of the product or process on the basis of being feasible to control.

2. The method of claim 1, wherein determining the optimal mean values includes at least:
varying values of the selected one or more variables while keeping fixed the standard deviation of the selected one or more variables, and determining how varying these values affects parameters of the cumulative distribution function.

3. The method of claim 1, wherein optimizing the cumulative distribution function includes at least:
setting an optimization objective for each parameter of the cumulative distribution function subject to constraints on values of the selected one or more variables;
choosing a function in the parameters; and
calculating an optimal value for the function.

4. The method of claim 1, further comprising:
ranking the influence of all of the probabilistic controllable variables on the reliability in a vicinity of the optimal mean values of the selected one or more variables.

5. The method of claim 4, wherein ranking the influence includes at least:
local probabilistic sensitivity analysis based on root sum of squares techniques.

6. The method of claim 4, wherein ranking the influence includes at least:
tolerance design-based functional analysis of variance (ANOVA) analysis.

7. A method to determine the effect of probabilistic design variables of a product or process on the reliability of the product or process, the method comprising:
formulating a cumulative distribution function that represents the reliability in terms of one or more parameters;
analytically deriving the one or more parameters in terms of the probabilistic design variables; and
ranking the influence of the probabilistic design variables on the reliability to identify critical probabilistic controllable variables.

8. The method of claim 7, further comprising:
determining which of the critical probabilistic controllable variables it is feasible to control.

9. The method of claim 7, further comprising:
determining how the critical probabilistic controllable variables affect the reliability.

10. The method of claim 9, wherein determining how the critical probabilistic controllable variables affect the reliability includes at least:
determining which, if any, of the critical probabilistic controllable variables has a linear relationship to the one or more parameters; and
determining, which, if any, of the critical probabilistic controllable variables interacts with noise variables of the product or process.

11. The method of claim 7, further comprising:
optimizing the cumulative distribution function with respect to one or more of the critical probabilistic controllable variables.

12. The method of claim 11, wherein optimizing the cumulative distribution function includes at least:
setting optimization objectives for the parameters subject to constraints on values of the probabilistic controllable variables.
